(19) United States
(12) Patent Application Publication
(10) Pub. No.: US 2026/0210182 A1
(43) Pub. Date: Jul. 23, 2026

(54) DEVICE FOR PROVIDING AN INTERMEDIATE STEP FOR A LADDER

(71) Applicant: Jackson THIER, Dyersville, IA (US)

(72) Inventor: Jackson THIER, Dyersville, IA (US)

(21) Appl. No.: 19/032,612

(22) Filed: Jan. 21, 2025

(51) Int. Cl. E06C 7/08

(52) U.S. Cl. CPC E06C 7/081

(57) ABSTRACT

Disclosed herein is a device for providing an additional step to a ladder. In some embodiments, the device includes an intermediate step, one or more upper supports configured to be suspended from a first step of the ladder, and one or more lower supports configured to rest on a second step of the ladder. In some embodiments, the one or more upper supports are each independently a hook and the first step of the ladder is above the second step of the ladder.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The instant application relates to ladders. In particular, the instant application relates to a device for providing an additional step to a ladder.

### BACKGROUND

Ladders are used in many fields and industries to enable a user to ascend or descend from one point to another. Typically, a ladder includes two rails disposed apart from each other and steps suspended horizontally between the two rails. The length of each step of a ladder may vary as the horizontal distance between the rails varies. For example, the distance between the rails of a ladder may be wider at the base of the ladder than at the top of the ladder so the length of the steps near the bottom of the ladder will be longer than the length of the steps near the top of the ladder. While the dimensions of each step may vary, the spacing between each step of a ladder is typically consistent from the top to the bottom of the ladder.

### SUMMARY

Certain embodiments of the present disclosure describe a device for providing an additional step to a ladder including: one or more upper supports configured to be suspended from a first step of the ladder; one or more lower supports configured to rest on a second step of the ladder; and an intermediate step coupled to the one or more upper supports and the one or more lower supports, such that the intermediate step is disposed below the one or more upper supports and above the one or more lower supports; wherein the one or more upper supports are each independently a hook.

In some embodiments, the hook includes a distance between a tip of the hook and a back of the hook and the distance is configured to conform to a width of the first step of the ladder such that there is substantially no movement of the device when it is suspended from the first step of the ladder.

In some embodiments, the distance between the tip of the hook and the back of the hook can be adjusted.

In some embodiments, the lower support includes a first upright disposed on a first side of the intermediate step; a second upright disposed on a second side of the intermediate step; and a first crossbar disposed between the first upright and the second upright, the first crossbar configured to connect the first upright and the second upright such that the ends of the first upright and the second upright extend past the first crossbar.

In some embodiments, the first crossbar is configured to rest on the second step of the ladder and the ends of the first upright and the second upright which extend past the first crossbar are configured to bracket the second step of the ladder such that the device does not slide off of or kick-out from the second step of the ladder.

In some embodiments, the distance between the first upright and the second upright is configured to conform to a width of the second step of the ladder such that there is substantially no movement of the device when it rests on the second step of the ladder.

In some embodiments, the lower support further includes a second crossbar originating in the corner defined by the intermediate step and the second upright and terminating at the first upright, the second crossbar configured to connect the first upright and the second upright.

In some embodiments, the one or more upper supports are two upper supports, wherein each upper support is disposed at an opposite end of the intermediate step.

In some embodiments, the one or more lower supports are two lower supports, wherein each lower support is disposed at an opposite end of the intermediate step.

In some embodiments, the device includes one or more of steel, aluminum, molded plastic, and carbon fiber.

In some embodiments, the device includes one or more of steel and aluminum.

In some embodiments, the ladder includes a distance of between 8 and 18 inches between steps, between 10 and 14 inches between steps, or between 10 and 12 inches between steps.

In some embodiments, the ladder includes a distance of between 10 and 14 inches between steps or between 10 and 12 inches between steps.

In some embodiments, the ladder includes a distance of between 10 and 12 inches between steps.

In some embodiments, the ladder includes a distance of between 10 and 14 inches between steps.

In some embodiments, the intermediate step is disposed between the first step of the ladder and the second step of the ladder such that it is in line with the first step, second step, and rails of the ladder within a plane defined by the rails of the ladder.

In some embodiments, the intermediate step includes a skid-resistant surface.

In some embodiments, the skid-resistant surface includes a skid-resistant tape, corrugation, knurling, dimpling, diamond plate pattern, or a skid resistant coating.

Any one of the embodiments disclosed herein may be properly combined with any other embodiment disclosed herein. The combination of any one of the embodiments disclosed herein with any other embodiments disclosed herein is expressly contemplated.

### BRIEF DESCRIPTION OF THE DRAWINGS

The objects and advantages will be apparent upon consideration of the following detailed description, taken in conjunction with the accompanying drawings, in which like reference characters refer to like parts throughout, and in which:

FIG. 1A shows a side-on schematic of a device for providing an intermediate step to a ladder, according to some embodiments.

FIG. 1B shows a view from the front of a device for providing an intermediate step to a ladder, according to some embodiments.

FIG. 2A shows a side-on schematic of a device for providing an intermediate step to a ladder including a skid-resistant surface on the intermediate step, according to some embodiments.

FIG. 2B shows a view from the front of a device for providing an intermediate step to a ladder including a skid-resistant surface on the intermediate step, according to some embodiments.

FIG. 3A shows a view from the front of a ladder illustrating how a device for providing an intermediate step is attached to the ladder, according to some embodiments.

FIG. 3B shows a schematic of a side-on cross-section of a ladder and a device for providing an intermediate step to a ladder, illustrating how the device is attached to the ladder, according to some embodiments.

FIG. 3C shows an expansion of the side-on cross-section view of the ladder illustrating how one or more upper supports of the device for providing an intermediate step to a ladder are attached to the ladder, according to some embodiments.

FIG. 3D shows an expansion of the side-on cross-section view of the ladder illustrating how the one or more lower supports of the device for providing an intermediate step to a ladder are attached to the ladder, according to some embodiments.

FIG. 4A shows a view from the front of the ladder illustrating how the device for providing an intermediate step is attached to the ladder with a fastener for each of the one or more upper supports and one or more lower supports, according to some embodiments.

FIG. 4B shows a schematic of a side-on cross-section of the ladder and the device, illustrating how the device for providing an intermediate step to a ladder is attached to the ladder with a fastener for each of the one or more upper supports and one or more lower supports, according to some embodiments.

FIG. 4C shows an expansion of the side-on cross-section view of the ladder illustrating how one or more upper supports of the device for providing an intermediate step to a ladder are attached to the ladder with a fastener, according to some embodiments.

FIG. 4D shows an expansion of the side-on cross-section view of the ladder illustrating how the one or more lower supports of the device for providing an intermediate step to a ladder are attached to the ladder with a fastener, according to some embodiments.

### DETAILED DESCRIPTION

Many of the tasks for which ladders are used require standing on a step of the ladder to access a point in the space adjacent to the ladder. In some situations, the user of a ladder may need to stretch to reach a point adjacent to the ladder because the step of the ladder that the user is standing on is not quite high enough for the user to reach the point adjacent to the ladder. In other situations, the user of a ladder may need to stoop or bend their head or neck slightly, because the step of the ladder that the user is standing on to reach a point adjacent to the ladder is too close to the ceiling or another obstruction above the ladder such that the user cannot stand up straight on the ladder step. In still other situations, due to spacing between steps of a ladder, there may not be a comfortable step for a user to stand on where they do not have to either stretch to reach a point adjacent to the ladder or bend because of an obstruction above the ladder. It has been recognized that stooping, bending, or stretching to reach points adjacent to a ladder or to perform a task at a point adjacent to the ladder, can cause chronic pain in muscles and joints of the user. It has been recognized that consistent wide spacing of ladder rungs contributes to this issue of chronic pain in ladder users. Thus, there is a need for devices and methods which can reversibly add an intermediate step that is not too-close or too-far away from the point adjacent to the ladder which the user of the ladder needs to reach by standing on the ladder.

According to one aspect of the present invention, a device is disclosed for providing an additional step to a ladder. In certain embodiments, the device fixes the additional step between a first step and a second step of the ladder, the first step of the ladder being above the second step of the ladder. By providing an intermediate step between two steps of a ladder, the device can allow a user to reach a point in space adjacent to the ladder in such a way that the user does not have to bend their head or neck while standing on the first step of the ladder or stretch to reach the point in space while standing on the second step of the ladder. In some embodiments, the device is portable and can be reversibly attached and secured to a ladder and later removed. The Applicants found that by using the device their standing point on a ladder could be adjusted to the task to be performed from the ladder. The Applicants surprisingly found that by using embodiments of the device to adjust their standing point on a ladder as needed for the task to be performed, they could prevent neck, shoulder, and back pain because there was no need to stretch, bend, or stoop while on the ladder.

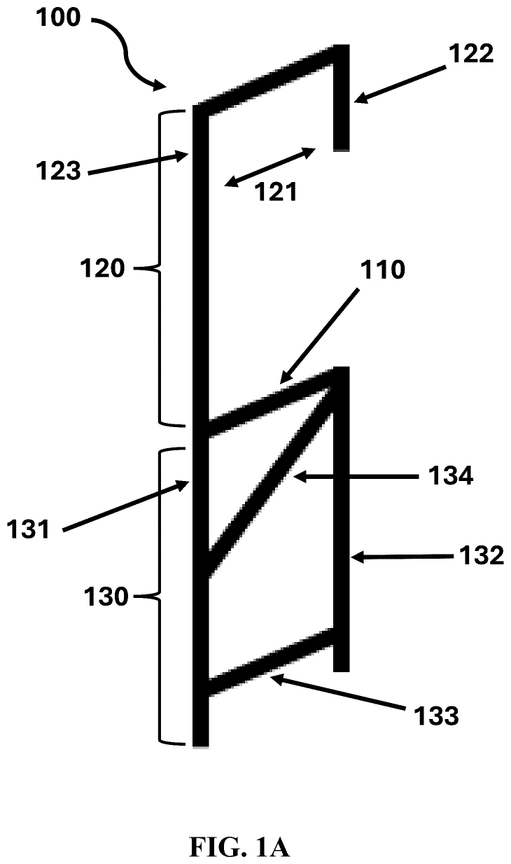

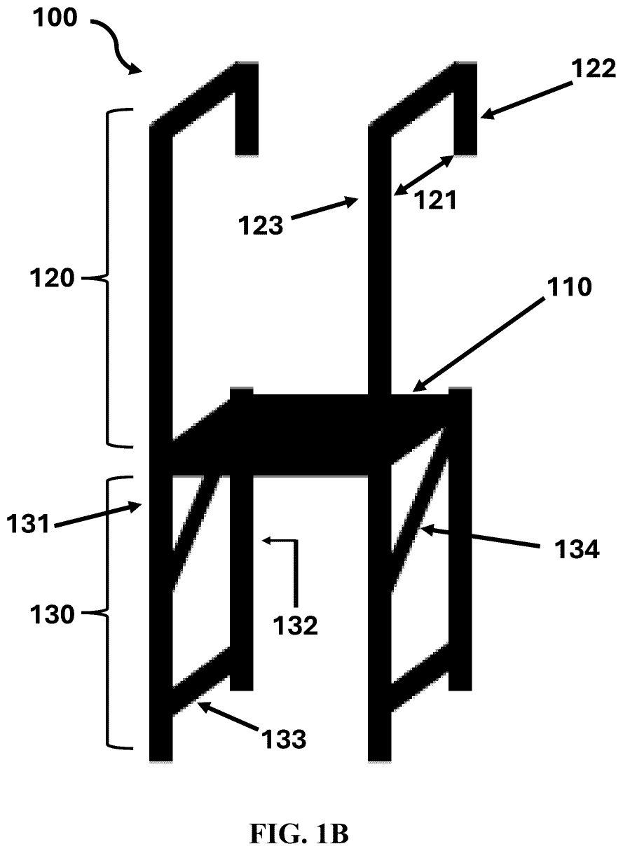

According to one aspect of the present invention a device is disclosed according to the illustrative schematic shown in FIGS. 1A-B. FIG. 1A shows a schematic of a side-on view of an exemplary device 100 for providing an additional step to a ladder. The device 100 includes an intermediate step 110 which is coupled to one or more upper supports 120 and one or more lower supports 130, such that the intermediate step is disposed below the one or more upper supports 120 and above the one or more lower supports 130. The one or more upper supports 120 are configured to be suspended from a first step of the ladder. The one or more lower supports 130 are configured to rest on a second step of the ladder. The first step of the ladder is above the second step of the ladder.

In the device 100, the one or more upper supports 120 are each independently configured to be a hook which wraps over the first step of the ladder such that the step of the ladder is secured between the back of the hook 123 and the tip of the hook 122. The distance 121 between the tip of the hook 122 and the back of the hook 123 is configured to conform to a width of the first step of the ladder such that there is substantially no movement of the device 100 when it is suspended from the first step of the ladder. As used herein, substantially no movement means that while the step may wiggle slightly or have sufficient play to be mounted or dismounted, there will not be enough movement to cause any danger to the user. In an alternative embodiment, the distance 121 between the tip of the hook 122 and the back of the hook can be adjusted.

In device 100, the one or more upper supports 120 are two symmetric upper supports. In an alternative embodiment, the one or more upper supports 120 are one upper support. In another embodiment, the one or more upper supports 120 are one upper support 120 and the one upper support 120 is disposed in the center of the additional step 110. In yet another embodiment, the one or more upper supports 120 are two upper supports 120 and each upper support 120 is disposed at an opposite end of the intermediate step 110.

In the device 100, the one or more lower supports 130 each independently include a first upright 131 disposed on a first side of the intermediate step 110 and a second upright 132 disposed on a second side of the intermediate step 110. A first crossbar 133 is disposed between the first upright 131 and the second upright 132 in such a way that the first crossbar 133 is attached to the first upright 131 and the second upright 132. In each of the one or more lower supports 130, the first crossbar 133 is disposed between the first upright 131 and the second upright 132 and the first crossbar 133 is configured to connect the first upright 131 and the second upright 132 such that the ends of the first upright 131 and the second upright 132 extend below or beyond the first crossbar 133, i.e., on the opposite side of the first crossbar 133 from the intermediate step 110. In the device 100, the first crossbar rests on a second step of the ladder and the respective ends of the first upright 131 and the second upright 132 which extend below or beyond the first crossbar are configured to bracket the second step of the ladder such that the device 100 does not slide off of or kick-out from the second step of the ladder. The distance between the first upright 131 and the second upright 132 is configured to conform to a width of the second step of the ladder such that there is substantially no movement of the device 100 when it rests on the second step of the ladder.

Optionally, a second crossbar 134 is disposed between the first upright 131 and the second upright 132 and the second crossbar 134 is configured to connect the first upright 131 and the second upright 132. As shown in FIGS. 1A-B, the second crossbar 134 originates in the corner defined by the intermediate step 110 and the second upright 132 and terminates at the first upright 131. However, the second crossbar 134 need not terminate in the corner defined by the intermediate step 110 and the second upright 132. In some embodiments, the second crossbar 134 is attached to the first upright 131 and 132 at respective points on each upright that are below the intermediate step 110 but above the first crossbar 133.

In the device 100, the one or more lower supports 130 are two symmetric lower supports. In an alternative embodiment, the one or more lower supports 130 are one lower support. In another embodiment, the one or more lower supports 130 are one lower support 130 and the one lower support 130 is disposed in the center of the additional step 110. In yet another embodiment, the one or more lower supports 130 are two lower supports 130 and each lower support 130 is disposed at an opposite end of the intermediate step 110.

In device 100, the one or more upper supports 120 are two symmetric upper supports 120 and the one or more lower supports 130 are two symmetric lower supports. In an alternative embodiment, the one or more upper supports 120 are one upper support 120 and the one or more lower supports 130 are one lower support 130. In another embodiment, the one or more upper supports 120 are one upper support 120 and the one or more lower supports 130 are two lower supports 130. In yet another embodiment, the one or more upper supports 120 are two upper supports 120 and the one or more lower supports 130 are one lower support 130.

A view from the front of an exemplary device for providing an additional step to a ladder 100 is shown in FIG. 1B. As shown in FIG. 1B, the device 100 includes two symmetric upper supports 120 each disposed on an opposite end of the intermediate step 110. As shown in FIG. 1B, the device includes two symmetric lower supports 130 each disposed at opposite ends of the intermediate step 110.

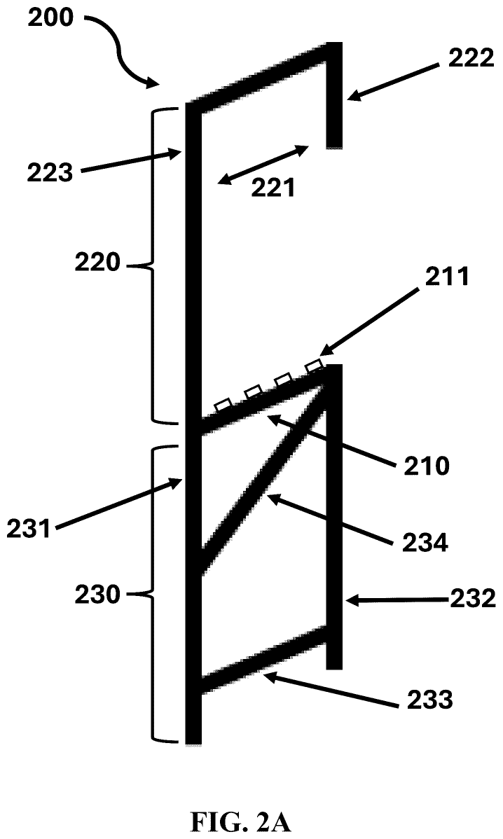

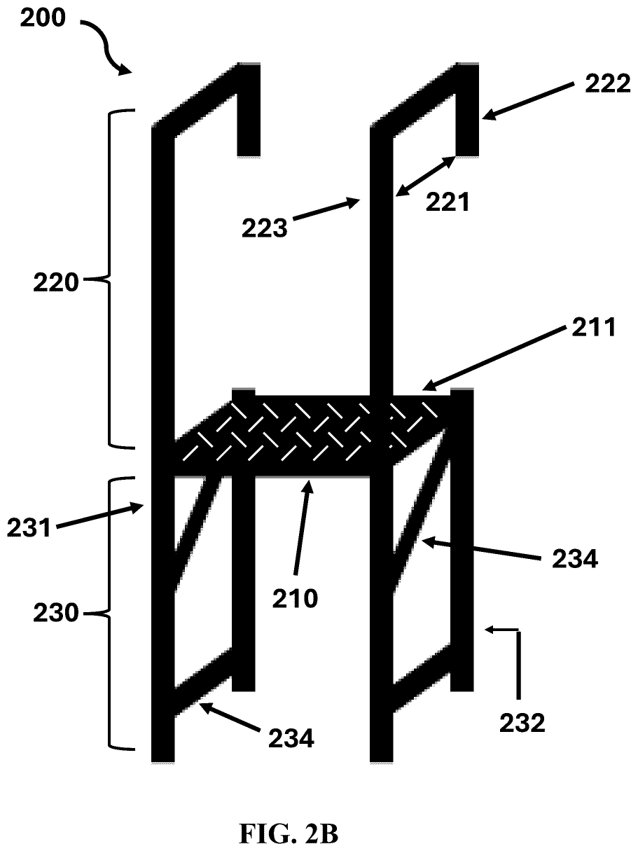

According to one aspect of the present invention a device is disclosed according to the illustrative schematic shown in FIGS. 2A-B. FIG. 2A shows a schematic of a side-on view of an exemplary device 200 for providing an additional step to a ladder. The device 200 includes an intermediate step 210 which is attached to one or more upper supports 220 and one or more lower supports 230. In device 200, the intermediate step 210 includes a skid-resistant surface 211. In some embodiments, the skid resistant surface 211 prevents the foot of a user standing on the intermediate step 210 from slipping or skidding off of the intermediate step 210. In some embodiments, the skid resistant surface 211 can be formed by molding or texturing the material on the upward side of the intermediate step. In an alternative embodiment, the skid resistant surface 211 can be formed by applying a coating or a layer to the upward side of the intermediate step. Non-limiting examples of a skid resistant surface 211 include a skid-resistant tape, corrugation, knurling, dimpling, diamond plate pattern, a skid resistant coating, or combinations thereof. In device 200, the one or more upper supports 220 are configured to be suspended from a first step of the ladder. In device 200, the one or more lower supports 230 are configured to rest on a second step of the ladder.

FIG. 2B shows a view from the front of an exemplary device 200 for providing an additional step to a ladder in which the intermediate step 210 includes a skid-resistant surface 211. The exemplary device 200 shown in FIG. 2B also includes two upper supports 220, each disposed at an opposite end of the intermediate step 210; and two lower supports 230, each disposed at an opposite end of the intermediate step 210.

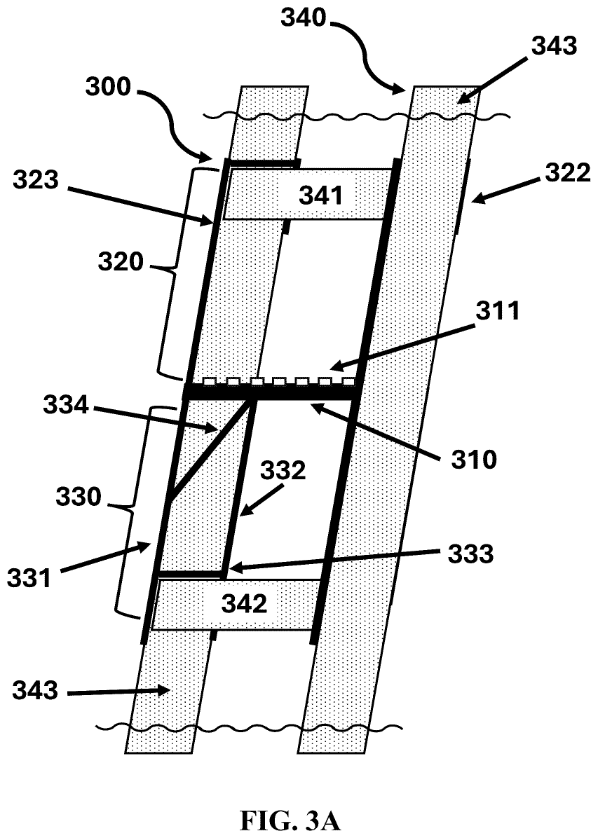

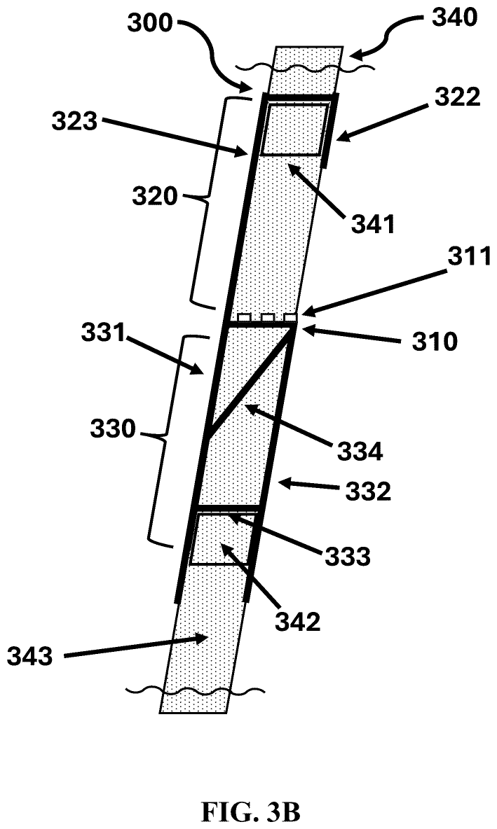

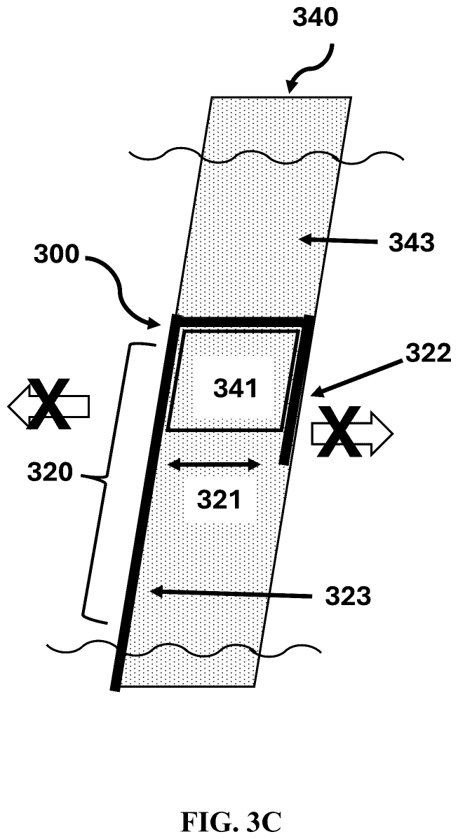

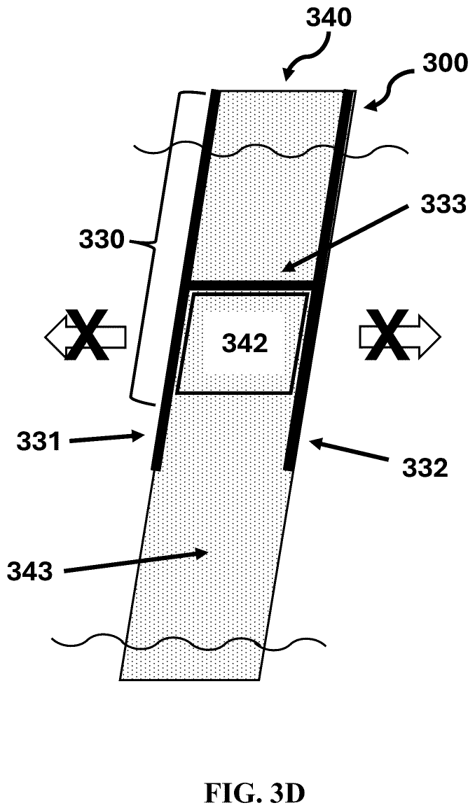

FIGS. 3A-3D show an illustrative schematic of an exemplary device for providing an additional step to a ladder 300 as it is attached to a ladder 340. FIG. 3A shows a view from the front of the ladder 340 while FIG. 3B shows a cross-section side-on view of the device 300 attached to the ladder 340. The device 300 includes an intermediate step 310 that further includes a skid-resistant surface 311. The device 300 includes two upper supports 320 which are each disposed at opposite ends of the intermediate step 310. The device 300 also includes two lower supports 330 which are each disposed at opposite ends of the intermediate step 310. As shown in FIGS. 3A-3B, the device 300 disposes the intermediate step 310 between the first step 341 and the second step 342 of the ladder 340. It can be seen in FIGS. 3A-3B that the intermediate step 310 is disposed in-line with the first step 341, the second step 342, and the rails of the ladder 343 within a plane defined by the rails of the ladder.

As shown in FIG. 3A, the device for providing an intermediate step to a ladder 300 is configured to fit within the rails 343 of the ladder 340. In some embodiments, the width of the intermediate step combined with the one or more upper supports and the one or more lower supports is configured to conform to the length of the steps 341/342 of the ladder 340, i.e., the distance between the rails 343 of the ladder. In some embodiments, the device 300 is configured to conform to the dimensions of the ladder 340 such that there is substantially no movement of the device from side to side within the rails of the ladder when it is fixed to the steps 341/342 of the ladder. Further, by configuring the width of the device 300 to the dimensions of the ladder 340, the size of the intermediate step is maximized to maximize the amount of room available for the user to stand on the intermediate step.

As shown in FIGS. 3A-3C, the two upper supports 320 are each independently configured to be hooks that wrap around a first step 341 of the ladder 340. As shown in FIG. 3C, each hook includes a distance 321 between the tip of the hook 322 and the back of the hook 323. In device 300, the distance 321 between the tip of the hook 322 and the back of the hook 323 is configured to conform to the width of the first step 341 of the ladder 340.

The distance 321 between the tip of the hook 322 and the back of the hook 323 is configured to conform to the width of the first step 341 of the ladder 340 such that there is substantially no movement of the device 300 when the upper support 320 is suspended from the first step of the ladder, as illustrated by the crossed-out arrows in FIG. 3C. In some embodiments, the distance 321 between the tip of the hook 322 and the back of the hook 323 can be adjusted.

As shown in FIGS. 3A-3B and 3D, the two lower supports 330 of the device 300 each include a first upright 331 disposed on a first side of the intermediate step 310 and a second upright 332 disposed on a second side of the intermediate step 310. The two lower supports 330 each include a first crossbar 333 configured to connect the first upright 331 and the second upright 332 such that the ends of the first upright 331 and the second upright 332 extend beyond and below the first crossbar 333. The two lower supports 330 of the device 300 each further include a second crossbar 334 which is originates in the corner defined by the intermediate step 310 and the second upright 332 and terminates at the midpoint of the first upright 331.

FIG. 3D shows an expanded side-on view of an exemplary lower support 330 and illustrates that the first crossbar 333 rests on the second step of the ladder 342 and the ends of the first upright 331 and the second upright 332 which extend past the first crossbar 333 are configured to bracket the second step of the ladder 342 such that the device 300 does not slide off of or kick-out from the second step of the ladder 342. The distance between the first upright 331 and the second upright 332 is configured to conform to a width of the second step of the ladder 342 such that there is substantially no movement of the device 300 when it rests on the second step of the ladder 342, as illustrated by the crossed-out arrows in FIG. 3D.

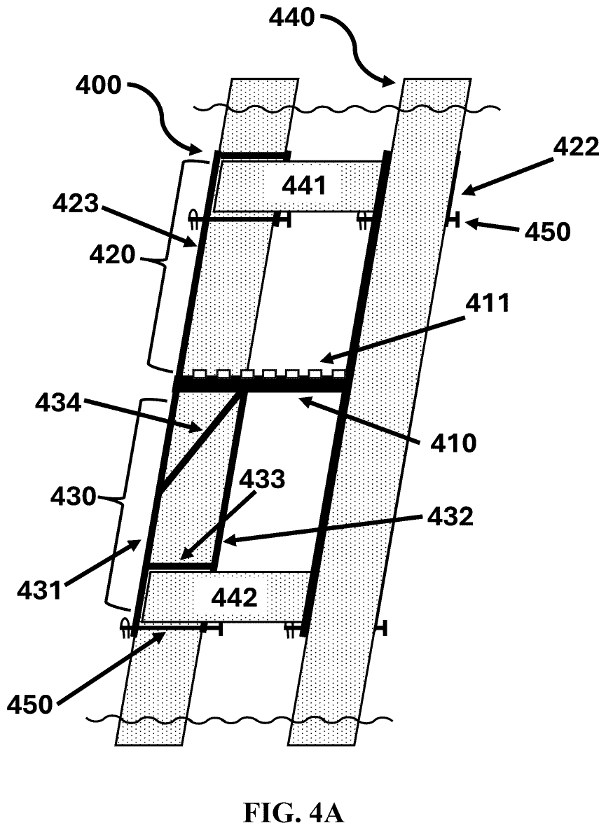

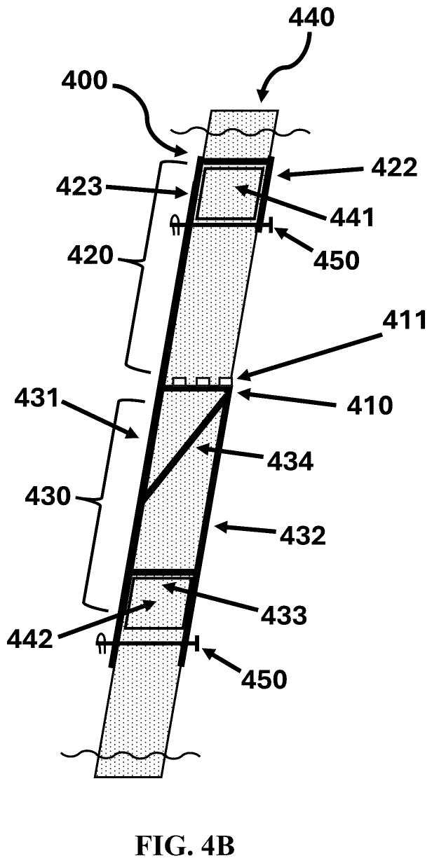

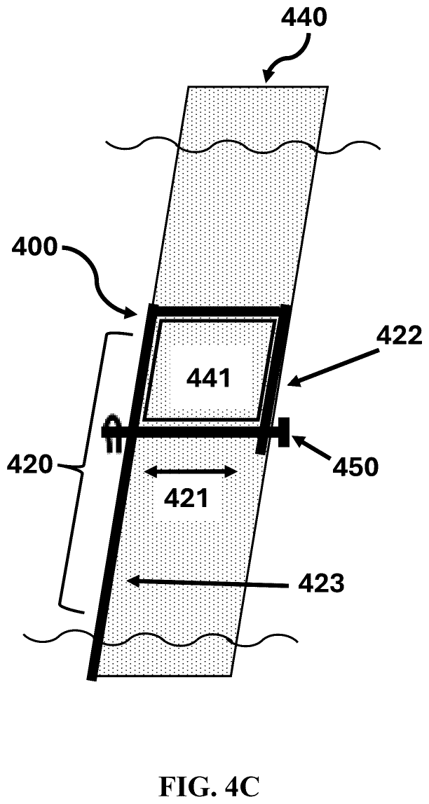

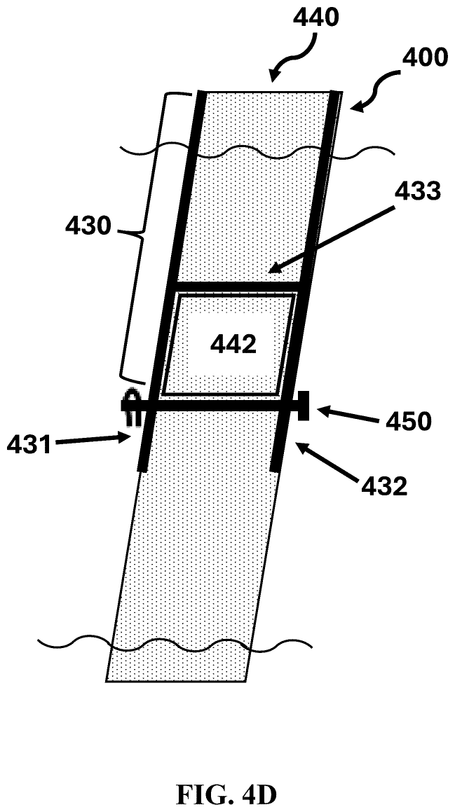

FIGS. 4A-4D show an illustrative schematic of an exemplary device for providing an additional step to a ladder 400 as it is attached to a ladder 440 wherein the device 400 includes a fastener 450 on each of the one or more upper supports 420 and each of the one or more lower supports 430. In this embodiment, the fastener 450 on each support 420/430 provides an additional safety measure to secure each support 420/430 to the respective step of the ladder 441/442 that the support 420/430 is attached to. Non-limiting examples of a fastener include a strap, a cable, or a bolt or rod secured by a pin.

In some embodiments, a device for providing an additional step to a ladder as disclosed herein is constructed from a specific material. In some embodiments, a device for providing an additional step to a ladder can include multiple materials. Non-limiting examples of materials which can be used to construct the device include steel, aluminum, molded plastic or carbon fiber. In some embodiments, the material can include steel or aluminum. In some embodiments, the material is aluminum. In some embodiments, the material is steel.

In some embodiments, a device for providing an additional step to a ladder can be configured to be used with a ladder that has a specific distance between steps. In an alternative embodiment, a device for providing an additional step to a ladder can be configured to be used with different ladders that have different distances between steps.

Non-limiting examples for the distance between the steps of a ladder include a distance of between 8 and 18 inches between steps, between 10 and 14 inches between steps, or between 10 and 12 inches between steps. In some embodiments, the ladder includes a distance of between 10 and 14 inches between steps or between 10 and 12 inches between steps. In some embodiments, the ladder includes a distance of between 10 and 14 inches between steps.

### EXAMPLES

Certain embodiments will now be described in the following non-limiting examples.

### Example 1

An exemplary device for providing an additional step to a ladder was constructed according to some embodiments of the present disclosure in analogous structure to the illustrative schematic shown in FIG. 2B. In the exemplary device, the intermediate step was constructed of steel and a grip tape was applied to the upward side of the step to provide a skid-resistant surface. The intermediate step was welded to two upper supports made of steel and disposed on opposite ends of the intermediate step. The intermediate step was further welded to two lower supports made of steel and disposed on opposite ends of the intermediate step. The two lower supports each included a first upright and a second upright. The first and second uprights of each lower support were connected by a first crossbar such that the ends of each upright extended below the first crossbar, and a second crossbar which originated in the corner defined by the intermediate step and the second upright and terminated near the midpoint of the first upright.

The exemplary device was configured such that the intermediate step was fixed between two steps of a four-foot step ladder, in-line with the steps of the ladder in analogous manner to the exemplary schematic shown in FIGS. 3A-3D. The two upper supports hooked over and were suspended from an upper step of the ladder, and the crossbar of each of the two lower supports rested on a lower step of the ladder. For each of the two upper supports, the distance between the tip of the hook and the back of the hook was configured such that the hook conformed to the width of the upper step so that each upper support was secured to the upper step and there was substantially no movement of the device when the device was secured to the upper step. In each of the two lower supports, the ends of the uprights which extended below the crossbar bracketed the lower step preventing the step from sliding or kicking-out from the ladder. The distance between each of the uprights in each lower support was also configured to conform to the width of the lower step of the ladder such that there was substantially no movement of the device when the device was secured to the lower step. The dimensions of the exemplary device were constructed to fit a ladder that had a distance of 12 inches between steps.

### Example 2

An exemplary device for providing an additional step to a ladder was constructed according to some embodiments of the present disclosure in analogous structure to the illustrative schematic shown in FIG. 2B. In the exemplary device, the intermediate step was constructed of diamond plate aluminum where the textured surface of the aluminum was on the upward side of the step to provide a skid-resistant surface. The intermediate step was welded to two upper supports made of aluminum and disposed on opposite ends of the intermediate step. The intermediate step was further welded to two lower supports made of aluminum and disposed on opposite ends of the intermediate step. The two lower supports each included a first upright and a second upright. The first and second uprights of each lower support were connected by a first crossbar such that the ends of each upright extended below the first crossbar, and a second crossbar which originated in the corner defined by the intermediate step and the second upright and terminated near the midpoint of the first upright.

The exemplary device was configured such that the intermediate step was fixed between two steps of a standard step ladder, in-line with the steps of the ladder in analogous manner to the exemplary schematic shown in FIGS. 3A-3D. The two upper supports hooked over and were suspended from an upper step of the ladder, and the crossbar of each of the two lower supports rested on a lower step of the ladder. For each of the two upper supports, the distance between the tip of the hook and the back of the hook was configured such that the hook conformed to the width of the upper step so that each upper support was secured to the upper step and there was substantially no movement of the device when the device was secured to the upper step. In each of the two lower supports, the ends of the uprights which extended below the crossbar bracketed the lower step preventing the step from sliding or kicking-out from the ladder. The distance between each of the uprights in each lower support was also configured to conform to the width of the lower step of the ladder such that there was substantially no movement of the device when the device was secured to the lower step. The dimensions of the exemplary device were constructed to fit a ladder that had a distance of 12 inches between steps.

It will be appreciated that while one or more particular materials or steps have been shown and described for purposes of explanation, the materials or steps may be varied in certain respects, or materials or steps may be combined, while still obtaining the desired outcome. Additionally, modifications to the disclosed embodiment and the invention as claimed are possible and within the scope of this disclosed invention.

1. A device for providing an additional step to a ladder comprising:
one or more upper supports configured to be suspended from a first step of the ladder;
one or more lower supports configured to rest on a second step of the ladder; and
an intermediate step coupled to the one or more upper supports and the one or more lower supports, such that the intermediate step is disposed below the one or more upper supports and above the one or more lower supports;
wherein the one or more upper supports are each independently a hook.

2. The device of claim 1, wherein the hook comprises a distance between a tip of the hook and a back of the hook and the distance is configured to conform to a width of the first step of the ladder such that there is substantially no movement of the device when it is suspended from the first step of the ladder.

3. The device of claim 2, wherein the distance between the tip of the hook and the back of the hook can be adjusted.

4. The device of claim 1, wherein the lower support comprises a first upright disposed on a first side of the intermediate step; a second upright disposed on a second side of the intermediate step; and a first crossbar disposed between the first upright and the second upright, the first crossbar configured to connect the first upright and the second upright such that the ends of the first upright and the second upright extend past the first crossbar.

5. The device of claim 4, wherein the first crossbar is configured to rest on the second step of the ladder and the ends of the first upright and the second upright which extend past the first crossbar are configured to bracket the second step of the ladder such that the device does not slide off of or kick-out from the second step of the ladder.

6. The device of claim 4, wherein the distance between the first upright and the second upright is configured to conform to a width of the second step of the ladder such that there is substantially no movement of the device when it rests on the second step of the ladder.

7. The device of claim 4, wherein the lower support comprises a second crossbar originating in the corner defined by the intermediate step and the second upright and terminating at the first upright, the second crossbar configured to connect the first upright and the second upright.

8. The device of claim 1, wherein the one or more upper supports are two upper supports, wherein each upper support is disposed at an opposite end of the intermediate step.

9. The device of claim 1, wherein the one or more lower supports are two lower supports, wherein each lower support is disposed at an opposite end of the intermediate step.

10. (canceled)

11. (canceled)

12. The device of claim 1, wherein the ladder comprises a distance of between 8 and 18 inches between steps, between 10 and 14 inches between steps, or between 10 and 12 inches between steps.

13. The device of claim 1, wherein the ladder comprises a distance of between 10 and 14 inches between steps or between 10 and 12 inches between steps.

14. The device of claim 1, wherein the ladder comprises a distance of between 10 and 12 inches between steps.

15. The device of claim 1, wherein the ladder comprises a distance of between 10 and 14 inches between steps.

16. The device of claim 1, wherein the intermediate step is disposed between the first step of the ladder and the second step of the ladder such that it is in line with the first step, second step, and rails of the ladder within a plane defined by the rails of the ladder.

17. (canceled)

18. (canceled)
